(19) United States
(12) Patent Application Publication
(10) Pub. No.: US 2003/0079804 A1
(43) Pub. Date: May 1, 2003

(54) WINDOW BLINDS MADE OF PROCESSED BAMBOO SLATS

(76) Inventor: Angela S.H. Hsu, Taipei (TW)

Correspondence Address: Angles S. H. Hsu, 235 Chung-Ho, Box 8-24, Taipei Taiwan, ROC, CN

(21) Appl. No.: 10/039,913

(22) Filed: Oct. 25, 2001

(51) Int. Cl. B27D 1/00; B27G 11/00

(52) U.S. Cl. 144/350

(57) ABSTRACT

This invention discloses a new method of manufacture of the processed bamboo slats for top quality window blinds. The method comprises six (6) steps: 1. slicing and smoothing, 2. steaming and boiling, 3. drying, 4. further smoothing, 5. assembling, and 6. cutting. Through a refinement process with chemical substances and physical efficiency, the bamboo slats can become pressure-resistant, moisture-proof, and insects-proof The processed bamboo slats can be manufactured by an integrated operation of mass production, which will dramatically lessen the cost of production of top quality bamboo window curtains.

### BACKGROUND OF THE INVENTION

1. Field of the Invention

The present invention relates to a window blinds made of processed bamboo slats. Particularly, this invention relates to a window blinds made of top quality bamboo slats through a refinement process with chemical substances and physical efficiency so that they can be pressure-resistant, moisture-proof, and insects-proof. It's method of slicing the bamboo slats into desired shapes and putting them together is comparatively much easier than that of conventional window blinds made of bamboo slats, which will dramatically lessen the cost of production and effectively upgrade the productivity.

2. Summary of the Invention

The main object of the present invention is to provide a new method of manufacture of window blinds made of top quality bamboo slats, particularly through an integrated operation of mass production. The method is first to select the top quality bamboos, slice them into strips, and smooth them; then steam the smoothed bamboo strips, dry them, polish them, and slice them into slats of desired shapes for the making of a variety of bamboo window blinds The most important of all is to have the bamboo slats undergo a refinement process with chemical substances and physical efficiency so that they can be pressure-resistant, moisture-proof and insects-proof. The procedure of slicing bamboo slats and the procedure of assembly of them into window blinds indicated in the method of the present invention are entirely different from those of the conventional methods of manufacture of bamboo window blinds. The unique procedure in the method of the present invention is to horizontally assemble the bamboo slats into a single, large piece of bamboo plate, press the bamboo plates into a multi-layer bamboo plate, and then vertically cut the multi-layer bamboo plate into desired sizes of bamboo slats, which will be used in manufacture of top quality bamboo window curtains As they can be produced in an integrated operation of mass production, the cost of production of top bamboo window blinds will be dramatically lessened.

### 3. BRIEF DESCRIPTION OF SEVERAL VIEWS OF THE DRAWINGS

FIG. 1 is a perspective view of U.S. Pat. No. 5,896,903 process of slicing the glued bamboo slats into the desired sizes.

FIG. 2 is the flowing chart of manufacture of the bamboo slats of the invention.

FIG. 3 is a perspective view of the sliced bamboo strips.

FIG. 4 is a perspective view of the bamboo strips being peeled off their bark and membrane

FIG. 5 is a perspective view of the smoothed bamboo strips being horizontally assembled into a single, large piece of bamboo plate.

FIG. 6 is a perspective view of the bamboo plates being heatedly pressed by a hydraulic press into a multi-layer bamboo plate.

FIG. 7 is a perspective view of the multi-layer bamboo plates being cut into pieces of window blinds leaves.

FIG. 8 is a perspective view of a window blinds made of the processed bamboo slats.

FIG. 9 is a perspective view of a Roman Shade made of the processed bamboo slats of the invention.

FIG. 10 is a perspective view of the combination of the multi-layer bamboo slats of the invention with other kind of bamboo slats by tongue and groove joints.

FIG. 11 is a perspective view of slices of the bamboo slats combined by tongue and groove joints.

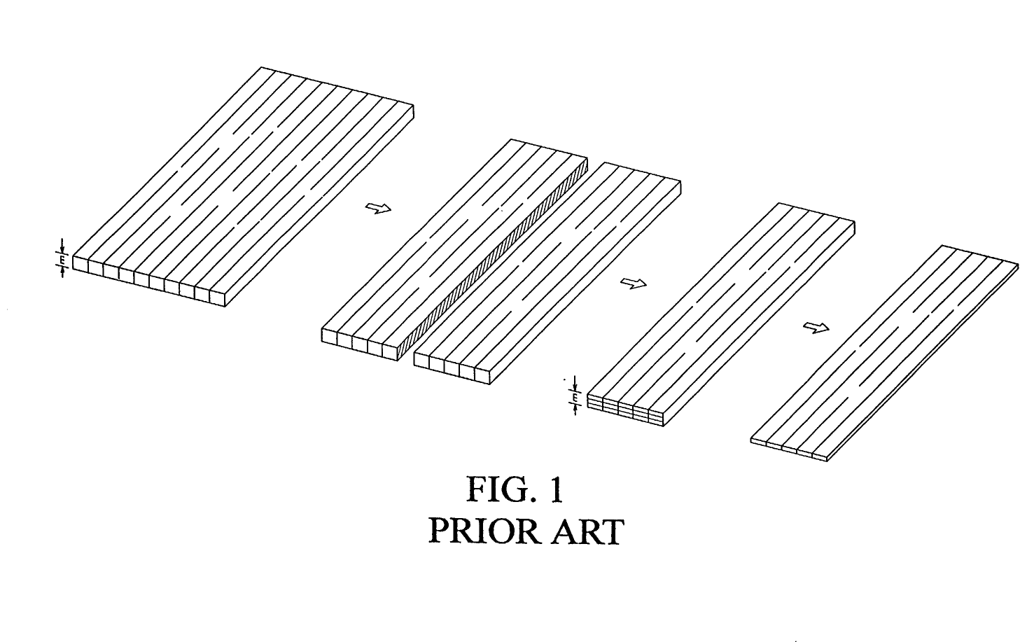

### 4. DETAILED DESCRIPTION OF THE INVENTION

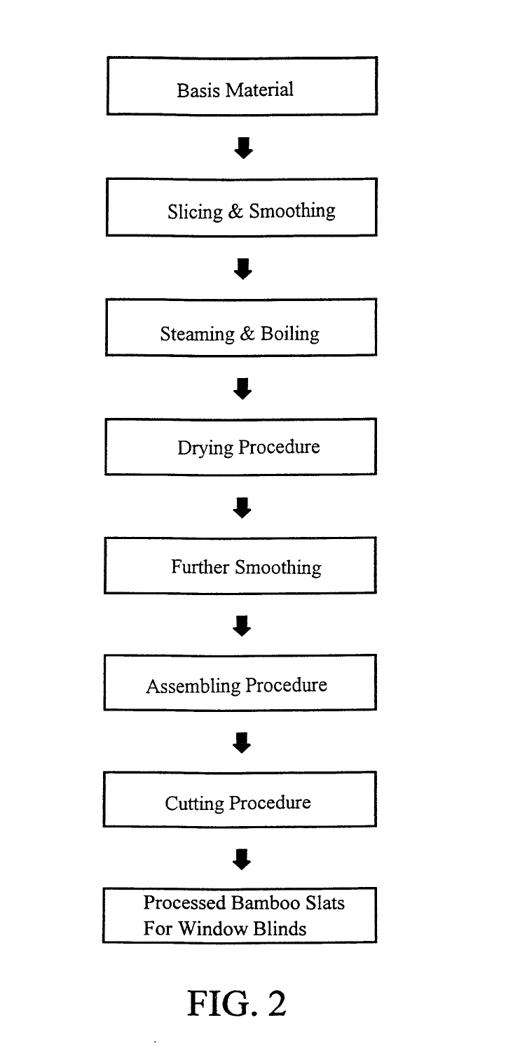

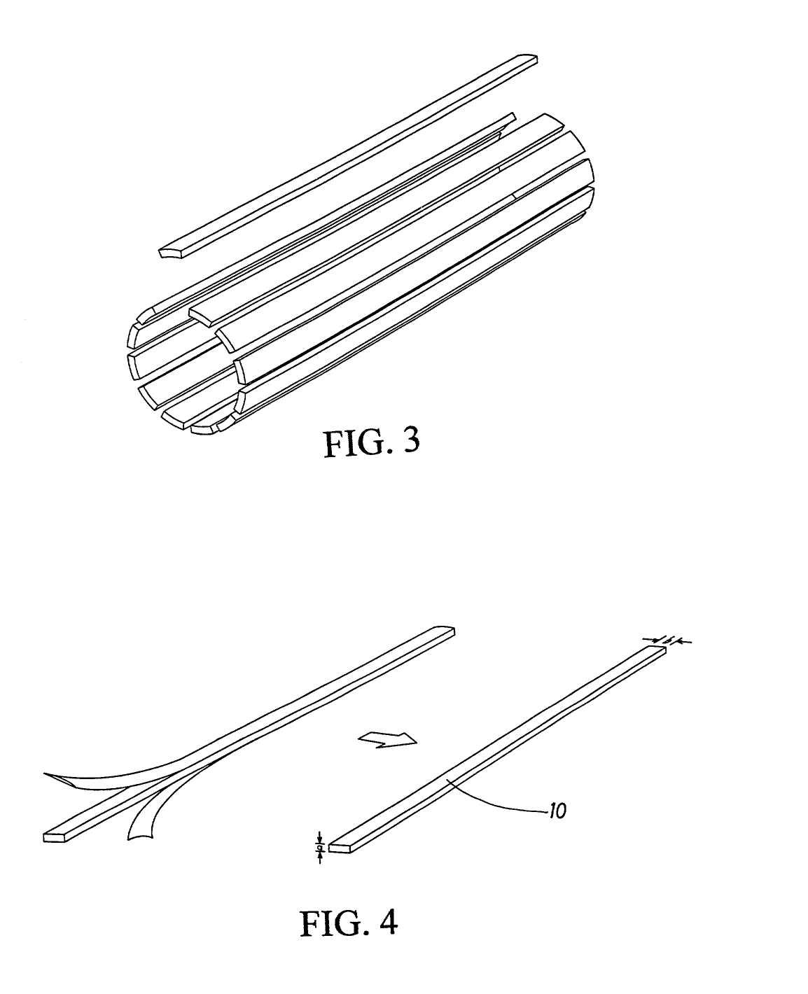

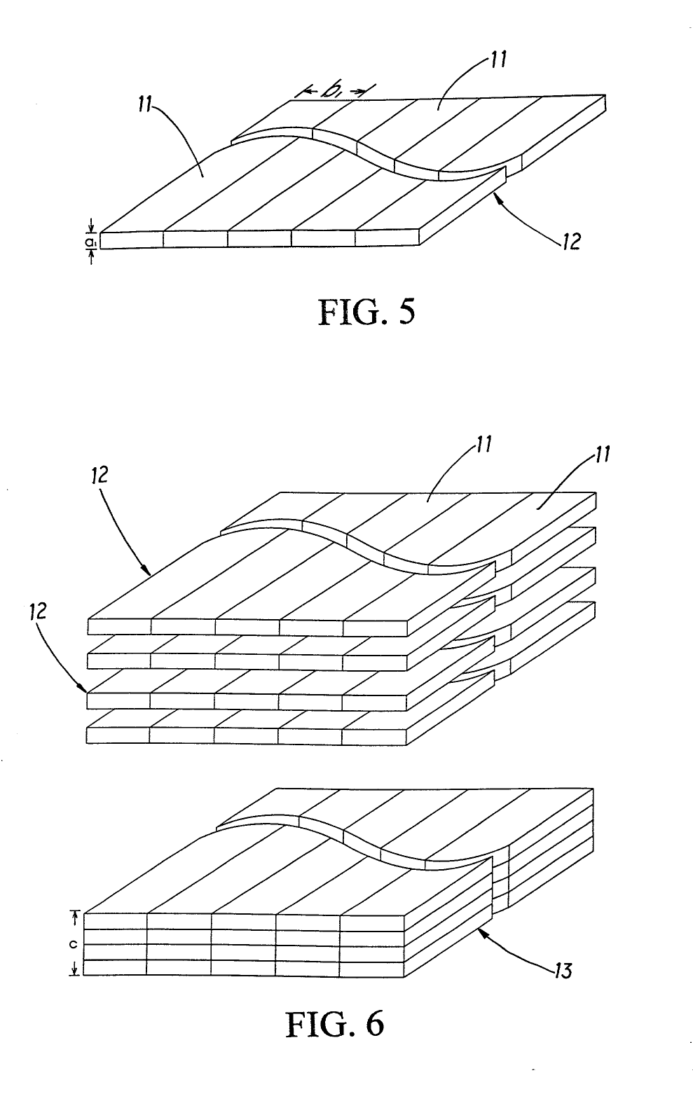

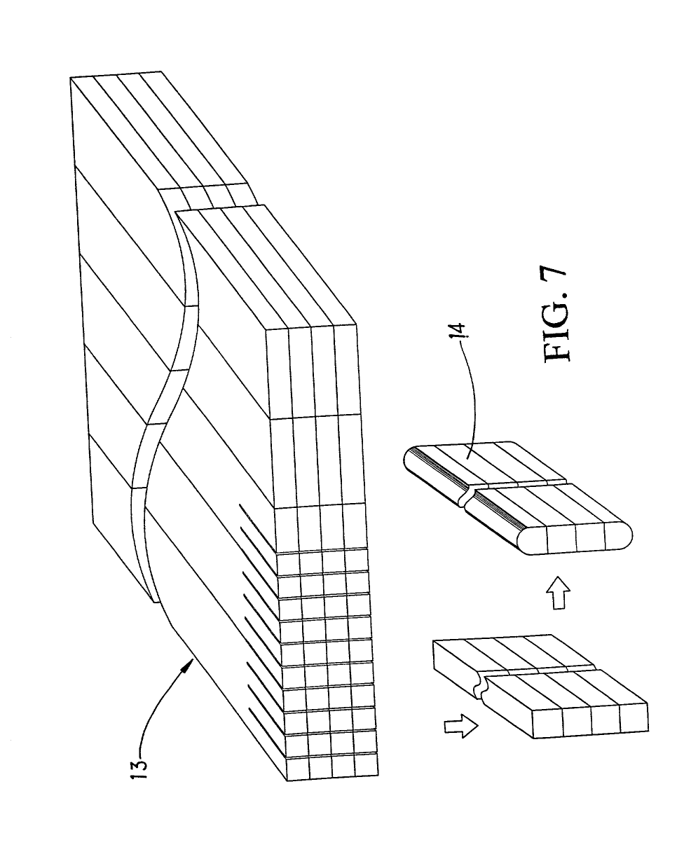

The invention's method of manufacturing a window blinds made of bamboo slats, as shown in FIG. 2, is to first select the 6-year-old bamboos and slice them into strips of desired length (i.e., 1050 m/m, 2000 m/m or 2600 m/m) as basis material. The manufacture method includes the following steps: (1) Slicing and Smoothing, as shown in FIGS. 3 and 4,—to slice the said bamboos into 7 to 12 pieces of small strips, each having the width of 18-27 mm; then to peel off their bark and membrane; and to smooth them and make each of them (10) have “a”—the thickness of 6-8 m/m and “b”—the width of 16-24 m/m, (2) Steaming and Boiling- to put the smoothed strips into a container with high pressure and high heat to steam for 10-120 minutes in order to get rid of the sugar they have contained; then to put them into a boiler filled with the water with 0.3-0.8% of NaOH to boil for a while, and then, to take them out of the boiler and rinse them thoroughly, after that, to put them back into the boiler with addition of the solution of anti-insects boride and bleach detergent, to boil for 2-5 hours, (3) Drying Procedure—to fully air dry the steamed and boiled bamboo strips at the temperature of about 40-60° C. and to make sure that the water they have contained will be effectively reduced to somewhere between 5-10% and their hardness will be upgraded as well, (4) Further Smoothing—to smooth the fully-dried bamboo strips on four directions, in order to transform each said bamboo strip (11) into an oblong bamboo strip having “a1”—the thickness of about 4.5-7 m/m and “b1”—the width of about 15-21 m/m, (5) Assembly Procedure—to horizontally assemble the smoothed bamboo strips of desired size (11) into a single piece of bamboo plate (12) (as shown in FIG. 5), the bamboo plate having “a1”—a thickness of about 4.5-7 m/m, and then to sand smooth the two sides of the bamboo plate (12); after that, to apply adhesive to the gaps between the bamboo plates and press them, in a pressing machine under high temperature and high heat, into a multi-layer (i.e., 3-15 layers) bamboo plates (13) (see FIG. 6), the said bamboo plats must have a thickness of 15-45 m/m at the best, (6) Cutting Procedure-to vertically cut the multi-layer bamboo plates (13) into bamboo slats of desired size with the thickness of 3 m/m (14), and then to apply the anti-moisture and anti-insects polish or wax to the surface of said bamboo slat so that a piece of the processed bamboo slat is turned out (as shown in FIG. 7)

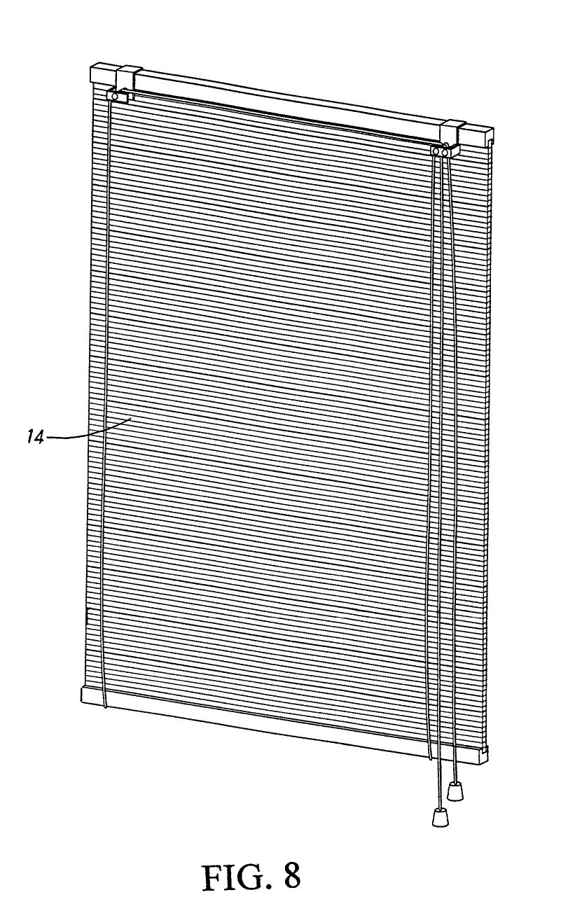

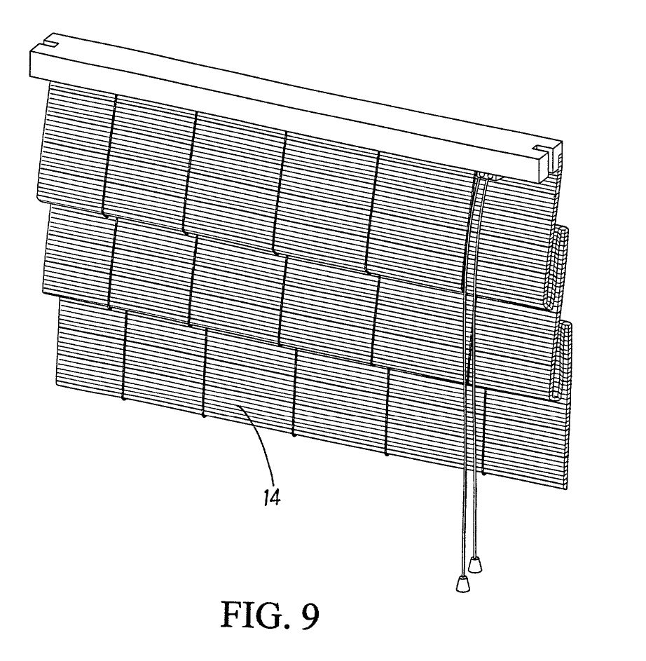

Please see FIGS. 8 and 9 and you will note that if the roll-up blinds or the Roman shades are made of the processed bamboo slats of the invention, they will be of better pressure-resistance and stronger hardness. In other words, any blind or Roman shade made of the invention's processed bamboo slats is the best of its kind.

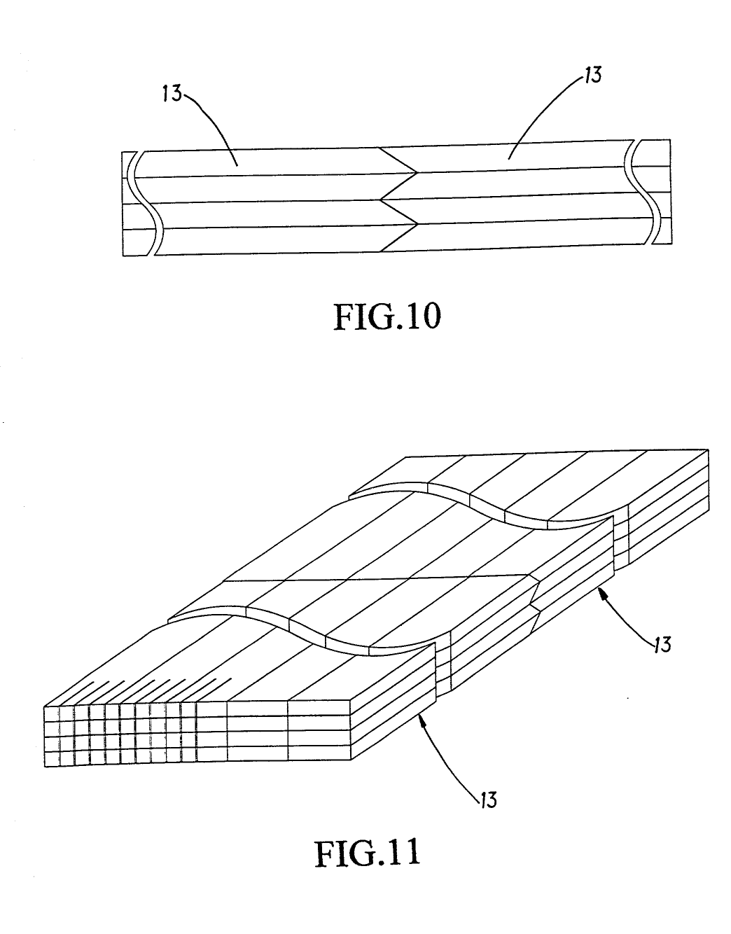

Furthermore, please take a look at FIGS. 10 and 11 and you will note that the invention's multi-layer bamboo plates of desired size (13) can be combined with other multi-layer plates of the same size (13) by tongue and groove joints and become extended plates, which can be cut into longer slats suitable for making of larger window shades of 8 feet/10 feet more in length, or doors or window frames.

What is claimed is:

1. A method of manufacturing the processed bamboo slats for bamboo blinds comprising the steps of:
1. Slicing the selected bamboos into 7 to 12 pieces of bamboo strips, each having the width of 18-27 mm, then peeling off their bark and joints and smoothing them; after that, making each of them have the thickness of 6-8 m/m and the width of 16-24 m/m.
2. Steaming the smoothed bamboo strips in a container with high pressure and high heat for 10-120 minutes in order to get rid of the sugar they have contained: then boiling them in a boiler filled with water with 0.3%-0.8% of NaOH for a while, and then taking them out of the boiler and rinsing them thoroughly; after that, putting them back into the boiler with addition of the solution of anti-insects boride and bleach detergent and boiling for 2-5 hours.
3. Air-drying fully the steamed and boiled bamboo strips at the temperature of about 40-60° C. and making sure that the water they have contained will be effectively reduced to somewhere between 5-10% and their hardness will be upgraded as well.
4. Further smoothing the fully dried bamboo strips on four directions in order to transform each of them into an oblong bamboo strip having the thickness of about 4.5-7 m/m and the width of about 15-21 m/m.
5. Assembling horizontally the smoothed bamboo strips of desired size into a single piece of bamboo plate having the thickness of about 4.5-7 m/m and then sanding smooth the two sides of the bamboo plates; after that, applying adhesive to gaps between the bamboo plates and pressing them, in a pressing machine under high temperature and high heat, into a multi-layer bamboo plates having the thickness of 15-45 m/m at the best.
6. Cutting vertically the multi-layer bamboo plates into bamboo slats of desired size with the thickness of 3 m/m and then applying the anti-moisture and anti-insects polish or wax to the surface of said bamboo slats so that a piece of the processed bamboo slat is turned out.
